(19) United States
(12) Patent Application Publication
(10) Pub. No.: US 2008/0081162 A1
(43) Pub. Date: Apr. 3, 2008

(54) Process for the production of a decorative glass element

(76) Inventor: Franz Wurzl, Terfens (AT)

Correspondence Address: WENDEROTH, LIND & PONACK, L.L.P., 2033 K STREET N. W., SUITE 800, WASHINGTON, DC, 20006-1021, US

(21) Appl. No.: 11/905,459

(22) Filed: Oct. 1, 2007

(30) Foreign Application Priority Data
Oct. 3, 2006 (AT) GM 718/2006

(51) Int. Cl. B05D 3/12; B05D 3/10; B32B 3/30

(52) U.S. Cl. 428/210; 427/207.1; 427/292; 427/309

(57) ABSTRACT

A process for the production of a decorative glass element, in which a surface structure is introduced, preferably in an irregular pattern, into one or more regions of the surface of a glass body by mechanical and/or chemical treatment, wherein a coating (4, 4′) is applied region-wise to the surface of the glass body (6).

The invention concerns a process for the production of a decorative glass element, in which a surface structure is introduced, preferably in an irregular pattern, into one or more regions of the surface of a glass body by mechanical and/or chemical treatment. The invention further concerns a decorative glass element whose surface has roughened regions, in particular produced by a process according to the invention.

Processes of the general kind set forth have already been part of the state of the art for over 100 years (reference is directed here to DE 24 329 dating from the year 1883). Glass elements produced in accordance with that process are frequently also referred to as frosted glass. Such decorative glass elements suffer from the disadvantage that the glass element quickly becomes unsightly due to mechanical influences or soiling. The frosting effect is quickly lost as a result.

Therefore the object of the present invention is to provide a process with which it is possible to produce a decorative glass element in which the frosting effect is durable. In addition the object of the invention is to enhance the frosting effect in relation to a decorative glass element.

That object is attained by the features of claim 1 or claim 15.

A process of the general kind set forth in which a coating is applied region-wise to the surface of the glass body produces a markedly more impressive frosting effect and ensures that that effect also persists over a longer period.

It is advantageously provided that a crystal glass body is used as the glass body. It can preferably be provided that the glass body is cast. To produce a particularly decorative glass element it is provided that the glass body is at least region-wise ground, wherein it is then provided in a particularly preferred configuration that facettings are ground into the glass body.

In a preferred case the basic starting point is a glass body which has a substantially smooth surface. Such a surface is afforded in particular when the roughness depth is below 0.25 μm. Such a slight degree of roughness is achieved for example by grinding and/or polishing.

Finally, irregular patterns or a surface structure are applied into individual regions on a glass body by mechanical or chemical treatment. Such a mechanical treatment could be effected for example by sand blasting. It will be appreciated that the surface treatment for producing the surface structure can also be effected in a plurality of stages, that is to say by a plurality of mechanical and/or chemical treatment steps. A preferred variant provides that heated pearl glue is applied to the regions of the surface of the glass element, which have preferably, been mechanically pre-treated, the pearl glue region-wise tearing the surface upon cooling.

A chemical treatment could be effected for example by etching. In per se known manner it could then be provided that the etching operation is effected by HF, H₂SO₄ and/or mixtures thereof.

In a preferred case it is provided that the coating is applied at least in the region of the surface structure. By virtue thereof particularly good preservation of the region with surface structure is effected and a particularly marked reinforcement in the frosting effect can be achieved. That effect is particularly promoted if the coating has an interference layer, preferably a λ/4-layer. By virtue of such an interference layer, it is possible to achieve an effect which causes the surface to shimmer in accordance with a kind of mother of pearl. In a variant it is provided that the coating has a mirror layer. A further variant provides that a plurality of layers are applied to the glass body, in which respect it is particularly preferably provided that a mirror layer is applied at least region-wise to an interference layer. An embodiment provides that an interference layer is applied to the regions with a surface structure and a mirror layer is applied to the regions without a surface structure.

As stated in the opening part of this specification the invention also provides a decorative glass element whose surface has roughened regions, in which at least the roughened region has at least region-wise a coating. Besides better durability such a glass element is distinguished by markedly higher reflection capability and better discernibility. Such glass elements can therefore also serve as security elements where better visibility is required.

Ideally it is provided that the surface of the glass element has regions of differing roughness, with at least one region of low roughness and at least one roughened region of greater roughness, which has numerous—preferably irregular—depressions, wherein at least the region of greater roughness at least partially has the coating. It is particularly preferably appropriate in that respect if the region of lesser roughness is substantially smooth, at any event involves a roughness depth of below 0.25 μm. Preferably the roughened regions have depressions of a roughness depth of between 0.25 μm and 0.5 mm, preferably of between 0.25 μm and 0.01 mm.

The depressions can be formed in different ways. Thus for example in an embodiment it can be provided that the depressions extend relatively far into the glass body, in particular then the roughened region has depressions with a roughness depth of up to 0.2 mm. Such a structure is ideally covered with a mirror layer so that a particularly pronounced reflection effect is achieved. In the configurations in which the roughened region has depressions which only extend up to about 0.01 mm into the glass element, a particularly good mother of pearl effect can be achieved by the application of an interference layer, preferably a λ/4-layer, which produces a better scatter reflection. It will be appreciated that the application of a plurality of different kinds of layers is also possible, in which respect an embodiment provides that the glass body is of a facetted nature at the front side and the roughened region is arranged at the rear side of the glass element.

It is also possible to conceive of mixed forms with regions involving different depressions. For example it would be possible to form such a glass element by at least two regions of greater roughness with irregular depressions being arranged on the glass element, wherein the one region has depressions of a roughness depth of up to 0.2 mm and the other region has depressions of a roughness depth of up to 0.01 mm.

In the mirror layer or interference layer already described hereinbefore, the coating can be adapted to be partially reflecting, which is substantially already ensured in the case of an interference layer and which represents the extreme variant in the case of a mirror layer. A layer sequence of interference layer and mirror layer on the glass element are also conceivable.

The depressions in the glass element are ideally such that the frosting effect or also the interference effect is particularly pronounced. In that respect it has been found to be advantageous if the depressions have a large so-called aspect ratio. That signifies that the depth of the depression, that is to say the roughness depth, is markedly different in relation to the width of the depression. In the ideal case the depth is approximately the same as the width, while the ratio of depth to width in the case of laser treatment is even markedly above 1. A preferred embodiment provides that the glass element has facettings.

In order to achieve a pronounced frosting effect, it is not the entire glass that should be roughened. At least a region of more than 10%, ideally more than 25%, should be of a roughness depth of below 0.25 μm. It will be noted however that the roughened region should also not be excessively small in size so that it is provided that the roughened region occupies at least 15% and preferably at least 25% of the surface area of the glass element.

Further advantages and details of the invention are described hereinafter with reference to the specific description and the Figures. As the representation of the effect is not possible true-to-scale by means of simple Figures the following Figures are greatly exaggerated and in rough diagrammatic form.

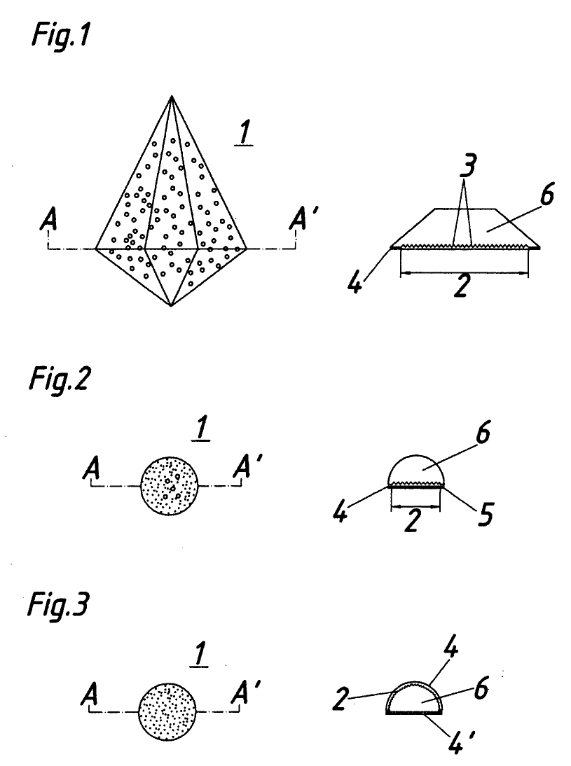

FIGS. 1 through 3 show three different embodiments by way of example of decorative glass elements according to the invention as a plan view (to the left) and along the section A-A′ of the plan view in cross-section (to the right).

FIG. 1 shows a decorative glass element 1 whose surface has a roughened region 2 with numerous depressions 3. They are arranged at the underside, the depressions in the glass element 1 being clearly discernible in the plan view. The glass body 6 which on the underside has the individual depressions 3 is visible in the cross-section. A coating 4 which for example could be a mirror layer is applied on the depressions, being shown in roughly diagrammatic form. The glass body itself could also have a subtle coloration so that the glass element is still substantially transparent but with a slight degree of coloration produces a slightly shimmering effect. The depressions in the present case are substantially of a roughness depth of up to 0.2 mm. The glass body 6 is ground and has facettings.

FIG. 2 shows a further embodiment of a glass element according to the invention, which is of an approximately hemispherical configuration. On the circular surface the glass body has depressions of up to 0.2 mm roughness depth and numerous depressions of a roughness depth of up to 0.01 mm. There is now applied thereto an interference layer 4 which produces a mother of pearl effect. In order to enhance that effect, a mirror layer 5 is additionally provided on the interference layer 4.

FIG. 3 shows a further embodiment, also of hemispherical form, in which case the depressions are provided on the hemispherical portion while the circular surface is smooth. A mirror layer 4′ is applied to the smooth surface and an interference layer 4 to the hemispherical surface.

Coating or mirroring of an irregular glass fracture surface gives rise to the impression of irregular waves on a river. Irregular zones which are arranged in surfaces and lines and which in turn comprise a large number of depressions or raised portions with a high aspect ratio (higher than the waves of the glass fracture surface) give rise to the impression of churned-up foamy water.

### EXAMPLES

1) Glass balls are scratched in the proximity of the equator and the poles broken off. A stencil is applied to the fracture surface and narrow zones are sand-blasted. The fractured and blasted ball half is briefly etched in a mixture of HF and H₂SO₄ in order to remove loose material and to take the sharpness away from the fracture edges. The fractured surface of the glass ball is coated and mirrored.

2) Glass balls are scratched in the proximity of the equator and the poles broken off. Finely structured regions with a high aspect ratio are produced on the fracture surface by means of a CO₂ laser. The fractured and blasted ball half is briefly etched in a mixture of HF and H₂SO₄ in order to remove loose material and to take the sharpness away from the fracture edges. The fractured surface of the glass ball is coated and mirrored.

3) A structured surface according to the invention is produced by applying and drying pearl glue on a sand-blasted surface of a precious stone blank. An interference system is vapor deposited on that surface and an impermeable aluminum mirror applied.

4) Glass balls are scratched in the proximity of the equator and the poles broken off. The fracture surface is carefully ground so that only the very highest raised portions are ground away. The ball half structured in that way is briefly etched in a mixture of HF and H₂SO₄. The fractured and ground surface of the glass ball is coated and mirrored.

The operation of producing the surface structure could be effected for example as follows:

The sand-blasted glass is heated and coated with pearl glue, the pearl glue is hot, at about 50°-60°. The pearl glue soaks into the structure, contracts during cooling and in so doing breaks the glass surface. Pearl glue and glass residues crumble off.

The roughness is ascertained in the form of the roughness depth. That is the spacing from the base profile in comparison with the reference profile. The base profile derives from the greatest depth of the depressions while the reference profile derives from the peaks of the depressions. The profile is ascertained with a sensing section device. A hemispherical sensing tip of a diameter of 2 μm is adopted as the sensing tip.

1. A process for the production of a decorative glass element, in which a surface structure is introduced into one or more regions of the surface of a glass body by mechanical, chemical or combined mechanical/chemical treatment, wherein a coating is applied region-wise to the surface of the glass body.

2. A process as set forth in claim 1 wherein said glass body is a crystal glass body.

3. A process as set forth in claim 1 wherein said glass body is at least region-wise ground.

4. A process as set forth in claim 1 wherein the mechanical treatment is effected by sand blasting.

5. A process as set forth in claim 1 wherein an adhesive which shrinks upon hardening is applied to the pre-treated regions of the surface of the glass element, the adhesive region-wise tearing the surface upon cooling and drying.

6. A process as set forth in claim 5 wherein said adhesive is heated pearl glue.

7. A process as set forth in claim 1 wherein the chemical treatment is effected by etching.

8. A process as set forth in claim 1 wherein said coating is applied at least in the region of the surface structure.

9. A process as set forth in claim 1 wherein said coating has an interference layer.

10. A process as set forth in claim 1 wherein the coating has a mirror layer.

11. A process as set forth in claim 9 wherein a mirror layer is applied at least region-wise to said interference layer.

12. A process as set forth in claim 1 wherein an interference layer is applied to the regions with a surface structure and a mirror layer is applied to the regions without a surface structure.

13. A decorative glass element whose surface has roughened regions, wherein at least the roughened region has at least region-wise a coating.

14. A glass element as set forth in claim 13 wherein the surface of said glass element has regions of differing roughness, with at least one region of low roughness and at least one roughened region of greater roughness, which has numerous depressions, wherein at least the region of greater roughness at least partially has the coating.

15. A glass element as set forth in claim 14 wherein the region of lesser roughness is substantially smooth, at any event involves a roughness depth of below 0.25 μm.

16. A glass element as set forth in claim 13 wherein the roughened region has depressions of a roughness depth of between 0.25 μm and 0.5 mm.

17. A glass element as set forth in claim 13 wherein said glass element is of a facetted nature at the front side and the roughened region is arranged at the rear side of the glass element.

18. A glass element as set forth in claim 14 wherein at least two regions of greater roughness with irregular depressions are arranged on the glass element, wherein the one region has depressions of a roughness depth of up to 0.2 mm and the other region has depressions of a roughness depth of up to 0.01 mm.

19. A glass element as set forth in claim 13 wherein the coating is at least partially adapted to be at least partially reflecting.

20. A glass element as set forth in claim 13 wherein the coating includes an interference layer at least in the roughened region.

21. A glass element as set forth in claim 20 wherein a mirror layer is arranged on the interference layer.

22. A glass element as set forth in claim 20 wherein a mirror layer is additionally arranged region-wise on the region of lesser roughness.

23. A glass element as set forth in claim 13 wherein the roughened region has numerous depressions whose depth-to-width ratio is >1.

24. A glass element as set forth in claim 13 wherein the glass element has facettings.

25. A glass element as set forth in claim 13 wherein the roughened region occupies at least 15% of the surface area of the glass element.
